(19) United States
(12) Patent Application Publication
(10) Pub. No.: US 2025/0200515 A1
(43) Pub. Date: Jun. 19, 2025

(54) Content Driven Open Vessel Data Assimilation Process and System

(71) Applicants: James Goughary, Jupiter, FL (US); Rene A. Stiegler, IV, Pensacola, FL (US); Scott Grzybowski, Fountain Hills, AZ (US)

(72) Inventors: James Goughary, Jupiter, FL (US); Rene A. Stiegler, IV, Pensacola, FL (US); Scott Grzybowski, Fountain Hills, AZ (US)

(21) Appl. No.: 18/845,485

(22) PCT Filed: Mar. 17, 2023
(86) PCT No.: PCT/US2023/015481

§ 371 Date: Sep. 10, 2024

Related U.S. Application Data
(60) Provisional application No. 63/321,139, filed on Mar. 18, 2022.

(51) Int. Cl. G06Q 10/10; G06F 3/0482

(52) U.S. Cl. CPC G06Q 10/10; G06F 3/0482

(57) ABSTRACT

A content driven open vessel data assimilation process consisting of utilizing at least one computing device with non-transitory computer readable medium for performing the function of containing data and manipulating user selected data and displaying the user selected data according to a data filter process where the data filter process further consists of a user interface connected with the at least one computing device where the user interface displays data and where the data includes user data concerning user events and content concerning a vessel. The process further configured to enable manipulation of the user interface to select specific vessel data from the vessel content and display selected specific vessel data to the user.

### CROSS REFERENCE TO RELATED APPLICATIONS

This application claims the benefit of previously filed U.S. provisional patent application No. 63/321,139 filed Mar. 18, 2022 for a “Content Driven Open Vessel Data Assimilation Process and System” which was the subject of PCT application PCT/US2023/015481 of the same name filed 17 Mar. 2023. The Applicants hereby claim the benefit of this provisional application and PCT application under 35 U.S.C. § 119. The entire content of these applications is incorporated herein by this reference.

### FIELD OF THE DISCLOSURE

The present invention pertains to a content driven open vessel data assimilation process consisting of utilizing at least one computing device with non-transitory computer readable medium for performing the function of containing data and manipulating user selected data and displaying the user selected data according to a data filter process where the data filter process further consists of a user interface connected with the at least one computing device where the user interface displays data and where the data includes user data concerning user events and content concerning a vessel. The process further configured to enable manipulation of the user interface to select specific vessel data from the vessel content and display selected specific vessel data to the user.

### BACKGROUND OF THE INVENTION

The prior art and current process for sharing available ship positions and vessel contents and characteristics to the shipping community consists of the following:
Ship owning companies send an email each day to Ship Brokers, Oil Companies, Trading Companies, etc. with their open positions that are available for hire in various parts of the world (See Prior Art FIGS. 1 and 2).
Ship Brokers then correlate the information manually into various spreadsheets and position lists correlating web sites or manually make a list of positions in chronological order by location and size of the ship.
Ship Brokers then send ship position lists of the combined ship positions from every owner to the same Oil Companies, Trading companies and any other potential end users that each owner has already sent to (Prior Art FIG. 3).

The above process is tedious, archaic, and redundant. In addition, the positions and conditions of the ships change quickly and the list can be inaccurate within minutes of hitting the send button.

Since the shipping market is real time and volatile, changes in the vessel's availability are an extremely important factor to the end user. When a ship owner charters a ship to an end user, it is very common that the owner places a vessel “on hold” for a period of twenty-four hours or longer for the end user to do their due diligence. This is commonly referred to as “being on subjects” or shorter versions are “on subs” or just “subs”. Not knowing which vessels are actually available in real time can be an extremely costly event for prior art system users.

Thus, there is a need in the art for a process that addresses the aforementioned problems in a manner that is robust and flexible so as to accommodate a full spectrum of users from vessel owners to ship brokers, oil companies and other end users of all types and sizes.

It therefore is an object of this invention to provide an improved vessel data assimilation distribution process that is near real time, easy to use and economical to install and operate.

### SUMMARY

Accordingly, an improved a content driven open vessel data assimilation process consists of utilizing at least one computing device with non-transitory computer readable medium for performing the function of containing and manipulating user selected data and displaying the user selected data according to a data filter process where the data filter process further consists of a user interface connected with the at least one computing device where the user interface displays data and where the data includes user data concerning user events and content concerning a vessel. The process further configured to enable manipulation of the user interface to select specific vessel data from the vessel content and display selected specific vessel data to the user.

All terms used herein are given their common meaning as known in the art such that “computing device” identifies a device for receiving, storing, processing, sending and manipulating data. Personal computers, laptops, wired and wireless devices, smart phones and all such computer devices now known or hereafter developed are included within the scope of the invention. Likewise, “data” includes any and all information relevant for the purposes of the invention relating in particular, but not by limitation, to vessels of all sorts.

In one aspect, the user interface is configured to enable user selection of specific data from many user events and vessel content and arrange presentation of the data as required by the user.

In one aspect, the presentation is manipulable according to specific data element, data variable name, data format and data order.

In another aspect, the data concerning many user events and content concerning a vessel is entered by a user authorized by a vessel owner.

In one aspect, users comprise a group of data end users consisting of commodity traders, oil companies, oil trading companies, ship brokers, and vessel owners.

In another aspect, the process further includes an audit process whereby selected specific vessel historical data from the vessel content is compared such that vessel performance characteristics over time are identified.

In one aspect, the process further includes vessel color codes for rapid identification of an available vessel and an unavailable vessel. In another aspect, an available vessel status is shown in a first color and an unavailable vessel status is shown in a second color.

In one aspect, the process further includes multiple vessels.

In one aspect, the user interface is subscription based.

In another embodiment, a content driven open vessel data assimilation process consists of:
utilizing at least one computing device with non-transitory computer readable medium for performing the function of containing data and manipulating user selected data and displaying the user selected data according to a data filter process; the data filter process further including:
a. a user interface connected with the at least one computing device where the user interface displays data and where the data includes user data concerning a number of user events and content concerning multiple vessels where the data concerning a number of user events and content concerning a particular vessel is entered by a user authorized by the particular vessel owner;
b the process further including user identification of vessel characteristics and availability for hire;
c. the process further configured to enable manipulation of the user interface to select specific vessel data from the plurality of vessel content and display selected specific vessel data to the user; and
d. where the process further includes displaying live time vessel color codes for rapid identification of an available vessel and an unavailable vessel.

In one aspect of this embodiment, the user interface is configured to enable user selection of specific data from many user events and vessel content and arrange presentation of the data as required by the user.

In another aspect, the presentation is manipulable according to specific data element, data variable name, data format and data order.

In one aspect, users comprise a group of data end users consisting of commodity traders, oil companies, oil trading companies, ship brokers, and vessel owners.

In another aspect, the process further includes an audit process whereby selected specific vessel historical data from the vessel content is compared such that vessel performance characteristics over time are identified.

In one aspect, an available vessel status is shown in a first color and an unavailable vessel status is shown in a second color.

According to another embodiment, a content driven open vessel data assimilation process consists of:
utilizing at least one computing device with non-transitory computer readable medium for performing the function of containing data and manipulating user selected data and displaying the user selected data according to a data filter process; the data filter process further consisting of:
a. a user interface connected with the at least one computing device where the user interface displays data and where the data includes user data concerning many user events and content concerning multiple vessels where the data concerning user events and content concerning a particular vessel is entered by a user authorized by the particular vessel owner;
b the process further including user identification of vessel characteristics and availability for hire;
c. the process further configured to enable manipulation of the user interface to select specific vessel data from the vessel content and display selected specific vessel data to the user; and
d. where the process further includes displaying live time vessel color codes for rapid identification of an available vessel and an unavailable vessel.

In one aspect, the users comprise a group of data end users consisting of commodity traders, oil companies, oil trading companies, ship brokers, and vessel owners.

In another aspect, the process further includes an audit process whereby selected specific vessel historical data from the vessel content is compared such that vessel performance characteristics over time are identified.

In one aspect, an available vessel status is shown in a first color and an unavailable vessel status is shown in a second color.

### DESCRIPTION OF THE DRAWINGS

Other objects, features and advantages of the present invention will become more fully apparent from the following detailed description of the preferred embodiment, the appended claims and the accompanying drawings in which:

FIG. 1 illustrates the Prior Art system of showing vessel information for a Company A;

FIG. 2 illustrates the Prior Art system of showing vessel information for a Company B;

FIG. 3 illustrates the Prior Art system of showing a composite list of vessel information for Company A, Company B, etc.;

FIG. 4 illustrates the content driven open vessel data assimilation process display of the present invention showing vessel information for vessels in the Gulf of Mexico;

FIG. 5 illustrates a display of the invention of FIG. 4 whereby an owner lists the status of all the owner's vessels making that information available to all users of the process;

FIG. 6 illustrates the use of the present invention for display of a world view of vessel information by regions to all users of the process;

FIG. 7 illustrates the use of the present invention in enabling the display of detailed analysis of the vessel data collected according to the process;

FIG. 8 is a flow diagram of adding a vessel to the present invention; and

FIG. 9 is a flow diagram of updating a vessel status according to the present invention.

### DETAILED DESCRIPTION OF EMBODIMENTS

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. In alternative embodiments, one or more process steps may be implemented by a user assisted process and/or manually. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

It should also be noted that a plurality of hardware and software-based devices, as well as a plurality of different structural components, may be utilized to implement the invention. Furthermore, and as described in subsequent paragraphs, the specific configurations illustrated in the drawings are intended to exemplify embodiments of the invention and that other alternative configurations are possible.

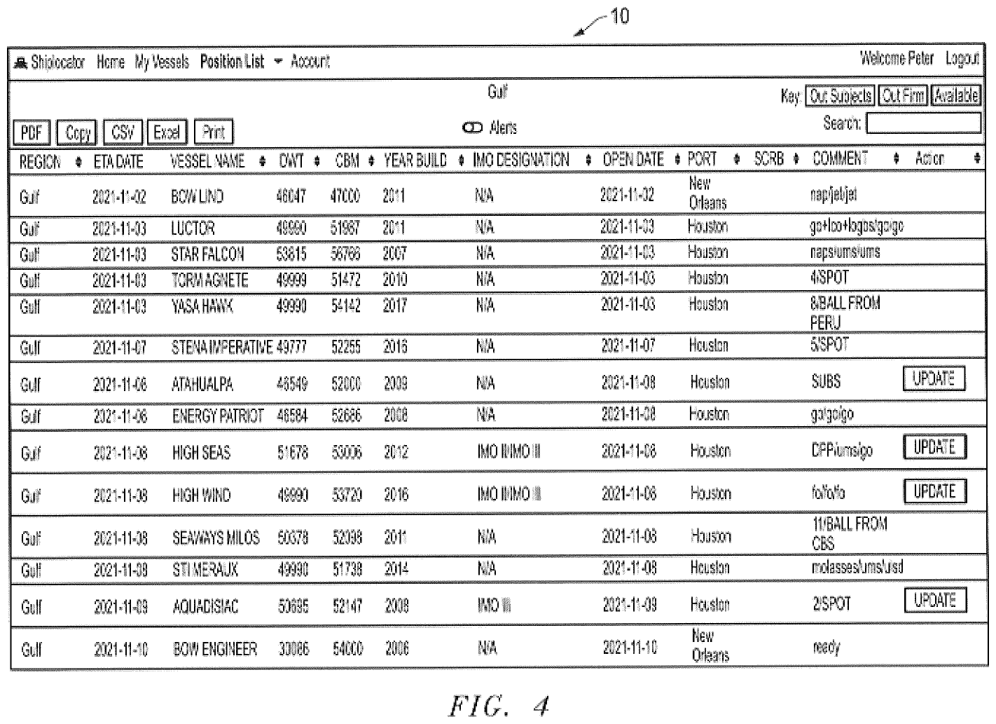

One embodiment of the present invention is illustrated by way of example in FIGS. 4-9.

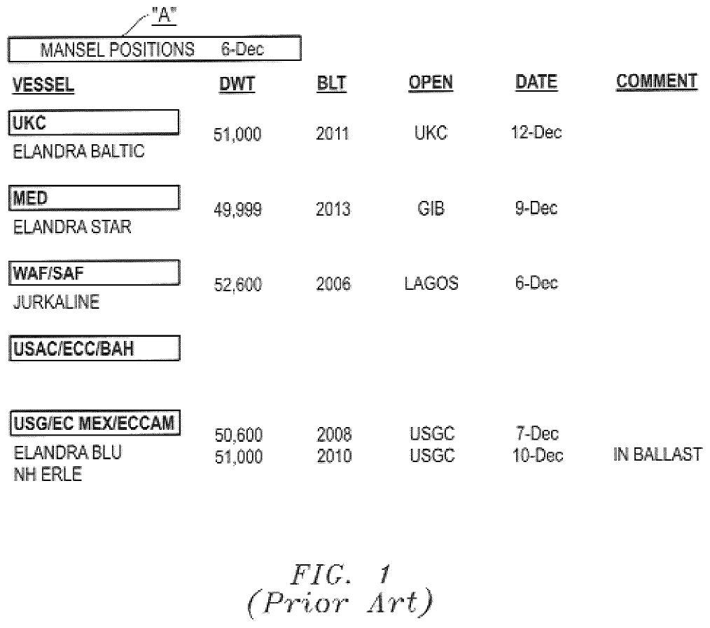

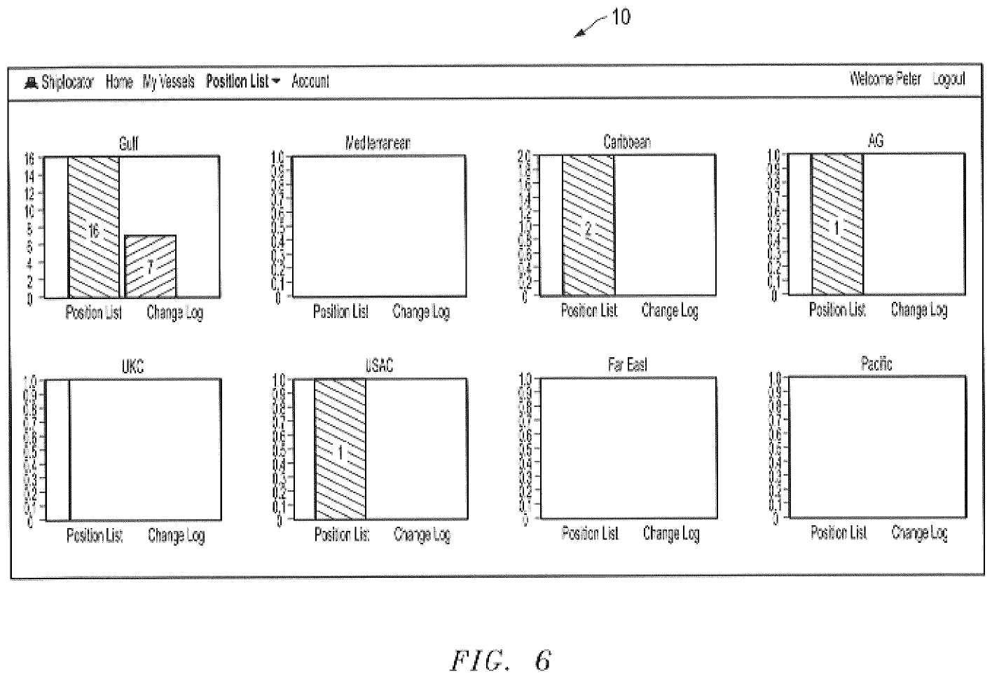

Referring to Prior Art FIGS. 1, 2 and 3, FIG. 1 shows the “open position” of Company “A” vessels. That is, it is a Prior Art example of one company's available tanker position list that is sent to several ship brokerage companies and various end users. Presently, the ship brokers then take each vessel position and manually add each vessel into a larger list that consists of all the other ship owners' vessels as well in each region of the world. This must be done to have a clear picture of all the available tanker positions in each region or load area of the world. Once the brokers list is done it is then sent to the same end users as well as other owners to have a clear picture of all the available vessels in any given region. (See FIG. 6). It is a terribly redundant exercise that the content driven open vessel data assimilation process of the present invention eliminates.

Additional information useful to users of the Prior Art system is also provided including for example, the weight of the vessel, year built, port in which it is located at the time and additional comments. While the availability of a vessel is the primary determining factor is vessel selection, obviously this additional information also weighs in the selection process.

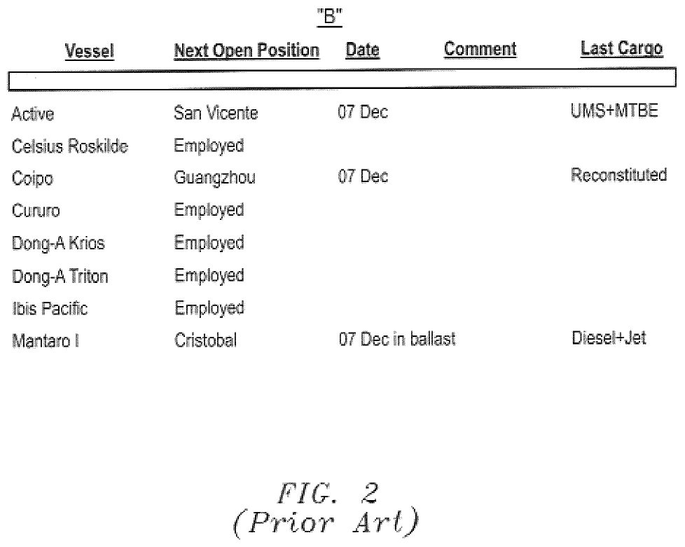

FIG. 2 shows the “open position” of Company “B” vessels and is another Prior Art example of a different company's available tanker position list that is also sent to several ship brokerage companies and various end users. Importantly, it is clear that the information provided by Company “A” and Company “B” are not the same and not presented in the same format. Collation of such disparate data results in errors and omissions prevalent in the Prior Art assimilation. That is, ship brokers take each vessel position and manually add each vessel into a larger list that consists of all the other ship owners' vessels as well in each region of the world. This must be done to have a clear picture of all the available tanker positions in each region or load area of the world. Once the ship brokers list is done, it is then sent to the same end users as well as other owners so that they may have a clear picture of all the available vessels in any given region. (See FIG. 6). Once again, it is a terribly redundant exercise that the content driven open vessel data assimilation process of the present invention eliminates.

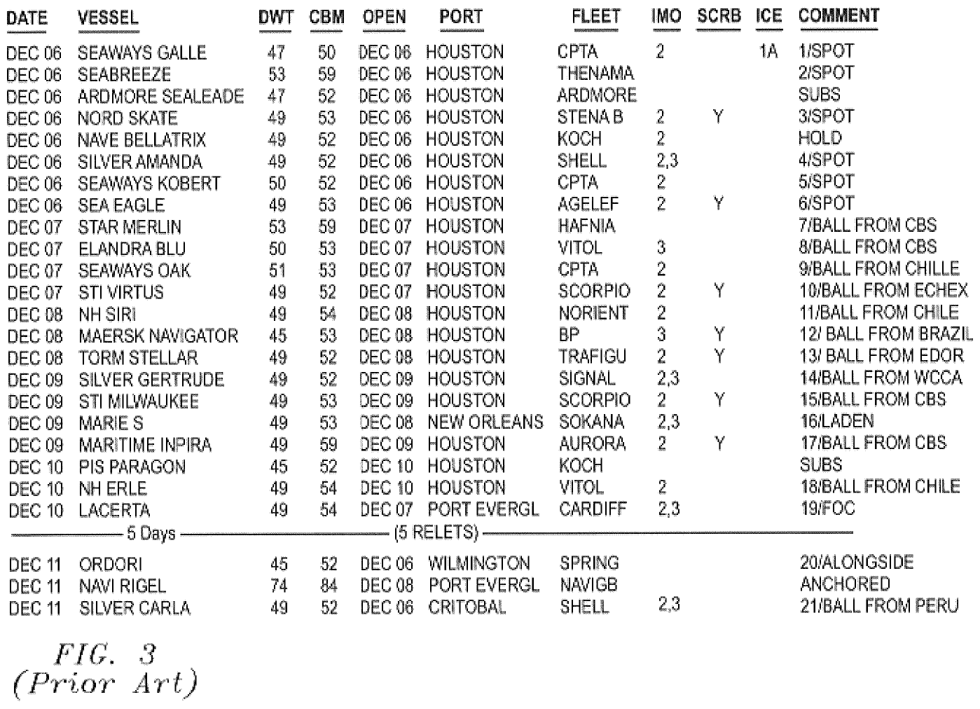

Referring now to Prior Art FIG. 3, the state of the art “Consolidated Position List” shown is an example of the Prior Art ship brokers resultant position list that is sent daily or even multiple times a day. This is a consolidation of all the vessel owners (sometimes 20-30 different owners or more) vessel status in one specific region. According to the Prior Art, however, by the time the position list is assembled and sent, the status of open/available positions for hire can be completely inaccurate. As will be described more fully hereafter, the present invention solves this problem by enabling the owners to directly enter availability updates of each of their particular vessels in “live time”.

FIG. 4 shows the content driven open vessel data assimilation process 10 of the present invention where, for example only and not by limitation, a region, the US Gulf Position List, is a live time “Update” display screen showing updates from each vessel position and availability for hire the moment it is updated by the ship owning company.

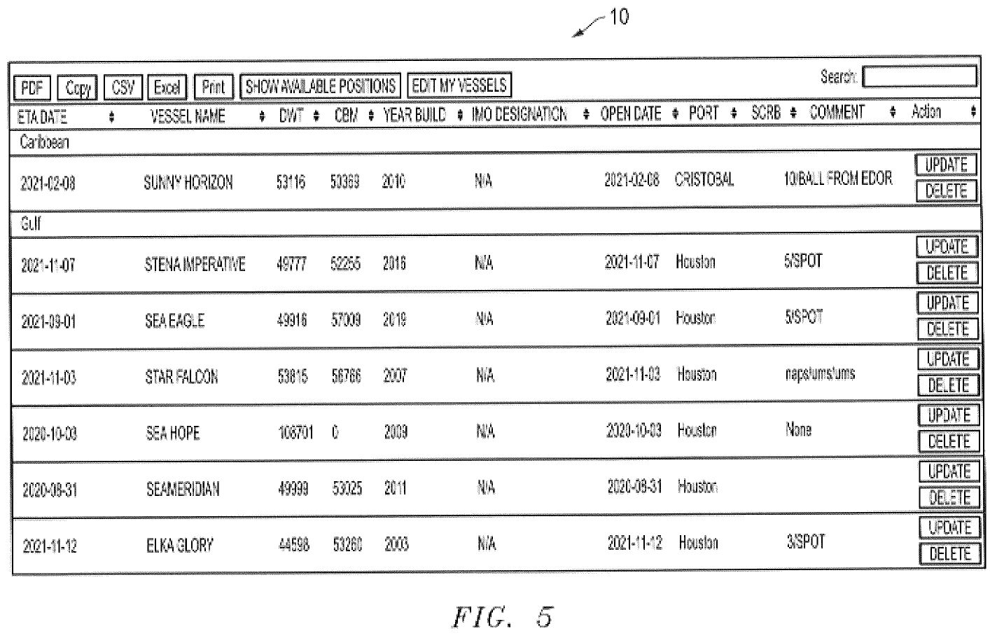

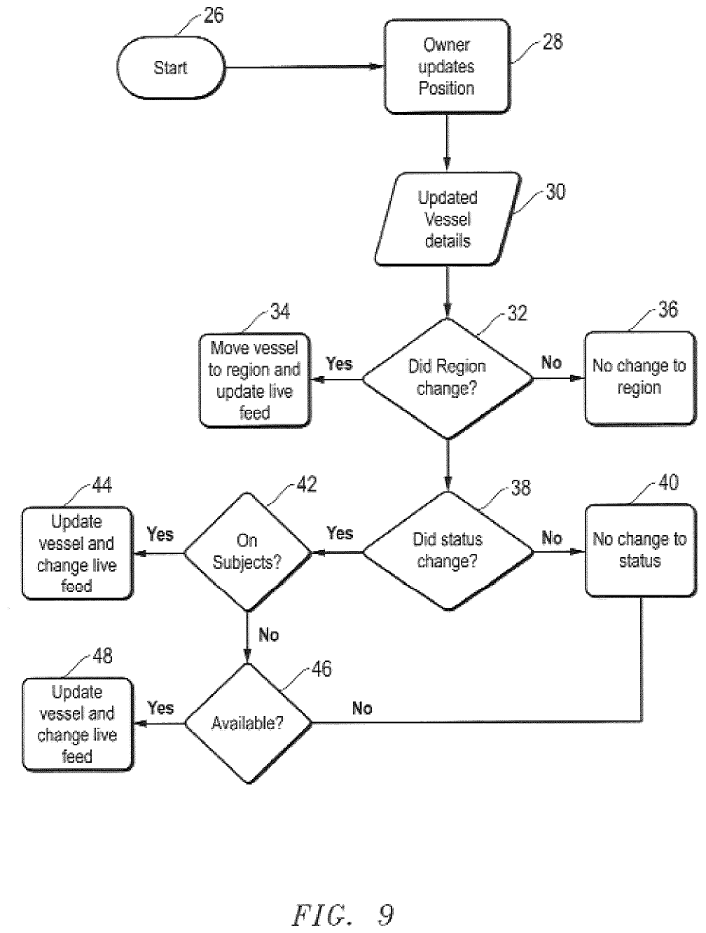

FIG. 5 illustrates the use of the present invention to allow a vessel owner or owners to edit their fleet. Most importantly, they update the vessel's position and availability for hire (See also FIG. 9). Once they have made their updates, they use the process of the present invention to generate a position list and then share this position list electronically in a common format to all other users of the system.

FIG. 6 illustrates the use of the present invention to allow all users to view in near real time, a display of the world view of vessel status grouped by region. From here the present invention allows them to drill down into the specific region's position list, as illustrated in FIG. 4, for example only and not by limitation. FIG. 6 represents the data via a bar graph, with the height of the bar indicating the number of vessels available for hire in that category. The x-axis of the graph shows the categories, and the y-axis shows the number of vessels available.

According to one aspect of the invention, users can hover a curser over each bar to view additional information, such as the specific sizes and types of vessels available in that category. The graph display is updated dynamically as vessel owners add or remove vessels from the system, ensuring that the information displayed is always up-to-date.

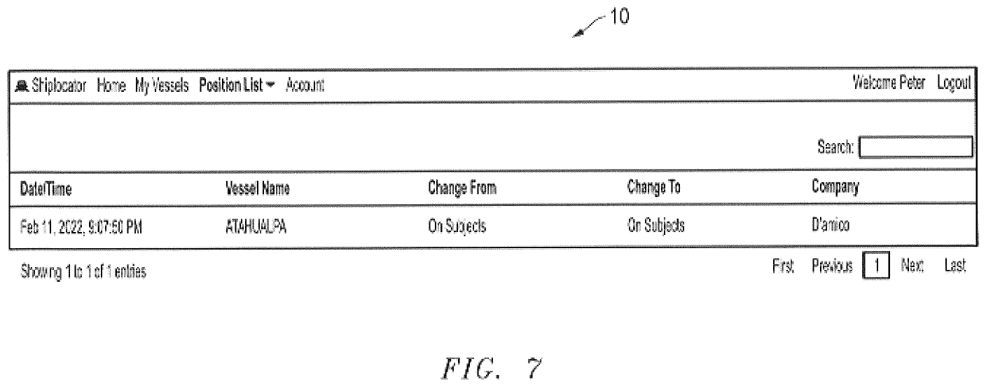

Referring to FIG. 7, the Figure illustrates the important use of the present invention for Auditing and Analytics. By means of the present invention, all data changes are captured in audit logs and this historical information can be easily viewed by clicking “audit” from the screen, for example. This information is fed to an analytics engine to assist in analytics and predictions. For example, for a specific owner, the question might be, what is the average time frame from “available” to “on subjects” or for the same scenario above, what is the average by region or time range. The present invention provides a user with critical, timely information that no Prior Art system can match.

At the present time, industry tackles the challenge of matching vessels with cargos by focusing on the charter broker. There are software tools that streamline the process of extracting information from charter broker emails. For example, the tools can extract open positions of vessels as well as cargo quotes. The tools convert that information into useful information that brokers can react to for bookings. Tools such as AXSReader by AXSMarine is one such example of tools that parses email into useful information.

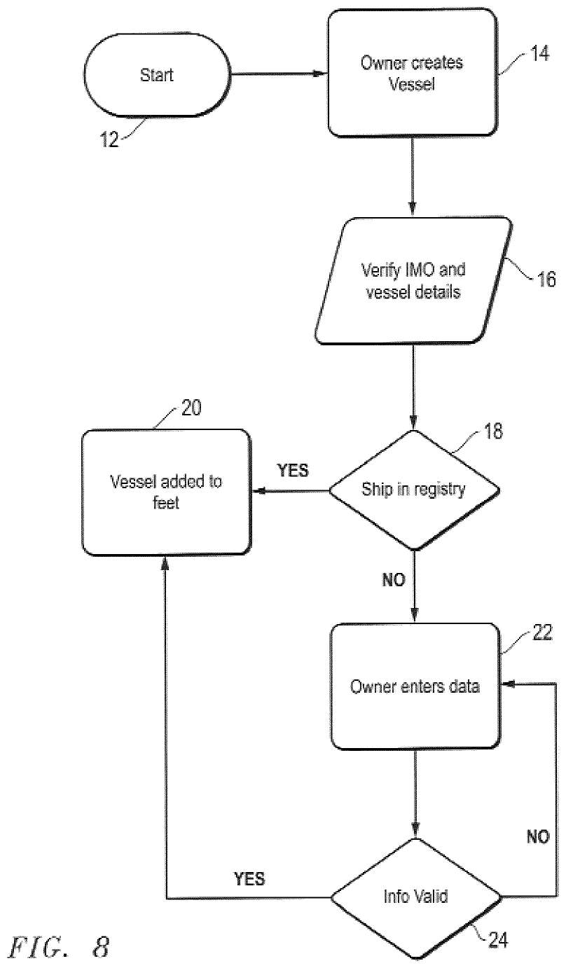

Referring to FIG. 8, in contrast, the present invention differs in that it is directed to, and focused on, and begins with, vessel owners and not the broker for the open positions. Vessel owners that are users of the present invention add their vessels according to the process set forth in FIG. 8. Unlike the Prior Art approach, individual vessel owners provide their open positions of each particular vessel by way of the central service of the present invention. This allows for near real-time data that the market as a whole can react to.

The present invention enables the display of vessels available for hire, grouped into categories based upon their size. For example only and not by limitation, the present invention can show can show MR (Medium range 300,000 barrel (bbl) capacity), LR (Long Range 500,000 barrel (bbl) capacity), Suezmax (1 million barrel (bbl) capacity etc. availability in real-time based upon specific geographic regions. Referring to FIG. 9, the categories are updated in real-time based on vessel owner input.

By way of further explanation, preferably the content driven open vessel data assimilation process of the present invention is, for example only and not by limitation, a subscription-based website that is a one-step platform updated in live time by the ship owning companies themselves. Referring to FIG. 8, each owner that is a user of the present invention starts at block 12 and enters each particular vessel at block 14. At block 16, the owner verifies International Maritime Organization (IMO) number and vessel details. At block 18, the system determines if the vessel is in the system registry. If “Yes” at block 20, the vessel is added to the user's fleet. If “No”, then at block 22, the owner enters the vessel registry data. At block 24, the system determines if the information entered is valid according to prior entries. If “No” the system returns the user to block 22. If “Yes” the vessel is added to the fleet at block 20.

After entering the vessel into the system per FIG. 8, according to the present invention the user then updates vessel status per FIG. 9, for the entire market to see in any location of the world and in near live time. The “update” process begins at “start” block 26 and proceeds to block 28 where the owner enters updated vessel position data. At block 30, the owner enters updated vessel details. At block 32, the system determines if the updated information changed the region where the vessel is located. If “Yes” at block 34, the system lists the proper region and updates the live feed of the system. If “No”, the system determines at block 36 that no change to the region was made and no update is required for that data,

Importantly, at block 38, the system determines if the vessel status has changed. If “No”, at block 40 the system determines that no change in status is required. If “Yes”, at block 42 the system queries whether the vessel status has changed to “On Subs”. If “Yes”, at block 44 the system updates that data for that vessel and the system changes the status on the live feed display. It should be understood by the preceding descriptions, that the “live feed” display is the view provided by the present invention to users and may consist of any number of selected informational views of data relevant to all listed vessels and each individual vessel as well.

If “No”, at block 42 the system queries at block 46 if the vessel is “available”. If “Yes”, the status is updated at block 48 and the live feed reflects the change. If “No”, no change in status is made at block 40.

In operation, therefore, according to the present invention, as the ships become available for hire or as they become utilized and unavailable (“on subs”), the owners themselves control the updates of the status of each of their vessels and display live to the entire market the status of the availability for hire of their ships. Currently, the only way that the end user is informed of minute by minute changes, is from spot market ship brokers constantly calling ship owners for updates and then spreading the latest information via phone or email. The “live” system of the present invention shows these changes the instant the owner updates his vessel on the website.

These changes may be color coded for easy and rapid identification by the users of the display of the present invention. For example, referring to FIG. 4, an available vessel that the ship owners were showing as open in the United States Gulf Coast (aka USG) on a given date would be listed in a first color, white or back font for example. When the vessel is placed “on subs” and is no longer available for a period of time, typically twenty-four hours or so, the owner then simply clicks the vessel to a second color mode displayed for the world to see in live time. RED, for example, displays to the world in almost live time that the ship is currently “on subs” and no longer available. Because of the volatility of the shipping market this is incredibly important and useful information users of the present invention can determine at a glance the direction of the market and the cost of shipping to move up or down. Further, the present invention has the ability to display vessels available for hire, grouped into categories based upon their size and Geographical location. The categories are updated in real-time based on vessel owner input. In addition to the “live” screen vessel position list, another-way the present invention preferredly represents the data is via a bar graph (see FIG. 6).

For authorized users of the process of the present invention that are vessel owners, the process boils down to the following simple steps: 1. Vessel owner updates available ships in any given market; and
2. Vessel owner changes status to RED, for example only, when the ship is placed “on subjects” to a potential client. (see FIG. 9).

This information, by means of the present invention, is instantly available for display to all users, thus ending the costly delay caused by duplicative data entering by non vessel owners required by the prior art. Certainly, any and all other vessel information deemed useful to users of the present invention, as illustrated in the Figures for example, may be added as well.

In sum, the content driven open vessel data assimilation process of the present invention is a unique system that allows ship owners anywhere in the world to input their available vessels in a shared system that provides a display to end users, commodity traders, oil companies, oil trading companies, brokers, other ship owners, etc. live time updated positions and vessel particulars in every logical region of the world that exports products via ships, for example only. This is a unique tool that streamlines the process of chartering ships and creates a desperately needed real time information flow for everyone involved in the oil markets, for example only.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

1. A content driven open vessel data assimilation process comprising:
utilizing at least one computing device with non-transitory computer readable medium for performing the function of containing data and manipulating user selected data and displaying said user selected data according to a data filter process;
said data filter process further comprising:
a. a user interface connected with said at least one computing device wherein said user interface displays data and wherein said data includes user data concerning a plurality of user events and consent concerning a vessel;
b the process further including user identification of vessel characteristics and availability for hire; and
c. the process further configured to enable manipulation of said user interface to select specific vessel data from said plurality of vessel content and display selected specific vessel data to said user wherein for each specific vessel, data changes are permitted only by a user identified as a vessel owner of the specific vessel.

2. The process of claim 1 wherein said user interface is configured to enable user selection of specific data from said plurality of user events and vessel content and arrange presentation of said data as required by said user.

3. The process of claim 2 wherein said presentation is manipulable according to specific data element, data variable name, data format and data order.

4. The process of claim 1 wherein the data concerning a plurality of user events and content concerning a vessel is only entered by a user authorized by a vessel owner to enter data for a specific vessel owned by the vessel owner.

5. The process of claim 1 wherein users comprise a group of data end user consisting of commodity traders, oil companies, oil trading companies, ship brokers, and vessel owners.

6. The process of claim 1 further including an audit process whereby selected specific vessel historical data from said plurality of vessel content is compared such that vessel performance characteristics over time are identified.

7. The process of claim 1 wherein the process further includes vessel color codes for rapid identification of an available vessel and an unavailable vessel.

8. The process of claim 7 wherein an available vessel status is shown in a first color and an unavailable vessel status is shown in a second color.

9. The process of claim 1 further including multiple vessels.

10. The process of claim 1 wherein said user interface is subscription based.

11. A content driven open vessel data assimilation process comprising:
utilizing at least one computing device with non-transitory computer readable medium for performing the function of containing data and manipulating user selected data and displaying said user selected data according to a data filter process
said data filter process filter comprising:
a. a user interface connected with said at least one computing device wherein said user interface displays data and wherein said data include user data concerning a plurality of user events and content concerning multiple vessels wherein the data concerning a plurality of user events and content concerning a particular vessel is only entered by a user authorized by said particular vessel owner;
b the process further including user identification of vessel characteristics and availability for hire;
c. the process further configured to enable manipulation of said user interface to select specific vessel data from said plurality of vessel content and display selected specific vessel data to said user; and
d. wherein the process further includes displaying live time vessel color codes for rapid identification of an available vessel and an unavailable vessel.

12. The process of claim 11 wherein said user interface is configured to enable user selection of specific data from said plurality of user events and vessel content and arrange presentation of said data as required by said user.

13. The process of claim 12 wherein said presentation is manipulable according to specific data element, data variable name, data format and data order.

14. The process of claim 11 wherein users comprise a group of data end users consisting of commodity traders, oil companies, oil trading companies, ship brokers, and vessel owners.

15. The process of claim 11 further including an audit process whereby selected specific vessel historical data from said plurality of vessel content is compared such that vessel performance characteristics over time are identified.

16. The process of claim 11 wherein an available vessel status is shown in a first color and an unavailable vessel status is shown in a second color.

17. A content driven open vessel data assimilation process comprising:
utilizing at least one computing device with non-transitory computer readable medium for performing the function of containing data and manipulating user selected data and displaying said user selected data according to a data filter process
said data filter process further comprising:
a. a subscription based user interface connected with said at least one computing device wherein said user interface displays data and wherein said data includes user data concerning a plurality of user events and content concerning multiple vessels wherein the data concerning a plurality of user events and content concerning a particular vessel is only entered by a user authorized by said particular vessel owner;
b the process further including user identification of vessel characteristics and availability for hire;
c. the process further configured to enable manipulation of said user interface to select specific vessel data from said plurality of vessel content and display selected specific vessel data to said user; and
d. wherein the process further includes displaying live time vessel color codes for rapid identification of an available vessel and an unavailable vessel;
e. wherein said user interface is configured to enable user selection of specific data from said plurality or user events and vessel content and arrange presentation of said data as required by said user; and
f. wherein said presentation is manipulable according to specific data element, data variable name, data format and data order.

18. The process of claim 17 wherein users comprise a group of data end users consisting of commodity traders, oil companies, oil trading companies, ship brokers, and vessel owners.

19. The process of claim 17 further including an audit process whereby selected specific vessel historical data from said plurality of vessel content is compared such that vessel performance characteristics over time are identified.

20. The process of claim 17 wherein a available vessel status is shown in a first color and an unavailable vessel status is shown in a second color.
